(19) United States
(12) Patent Application Publication
(10) Pub. No.: US 2026/0188879 A1
(43) Pub. Date: Jul. 2, 2026

(54) CASE FOR SECONDARY BATTERY, SECONDARY BATTERY INCLUDING THE CASE AND METHOD OF MANUFACTURING THE CASE

(71) Applicant: SAMSUNG SDI CO., LTD., Yongin-si (KR)

(72) Inventors: Inseop BYUN, Yongin-si (KR); Sanghyun KIM, Yongin-si (KR); Jaeyoung PARK, Yongin-si (KR)

(21) Appl. No.: 19/335,282

(22) Filed: Sep. 22, 2025

(30) Foreign Application Priority Data
Dec. 31, 2024 (KR) 10-2024-0202838

(51) Int. Cl. H01M 50/636; H01M 50/119; H01M 50/159; H01M 50/342; H01M 50/55

(52) U.S. Cl. CPC H01M 50/636; H01M 50/119; H01M 50/159; H01M 50/3425; H01M 50/55; H01M 2200/20

(57) ABSTRACT

A case for a secondary battery includes a body including an accommodation portion configured to accommodate an electrode assembly. A cover seals an open end of the accommodation portion. An electrolyte injection hole is formed in one side of the body. A sealing member is attached to the one side and seals the electrolyte injection hole. The sealing member includes an adhesive layer bonded to the body and a metal layer laminated on the adhesive layer.

### CROSS-REFERENCE TO RELATED APPLICATION

This application claims priority under 35 U.S.C. § 119 to Korean Patent Application No. 10-2024-0202838, filed in the Korean Intellectual Property Office on Dec. 31, 2024, the entire contents of which are hereby incorporated by reference.

### BACKGROUND

### Field

The present disclosure relates to a case for a secondary battery, a secondary battery including the case, and a method of manufacturing the secondary battery.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the electrode assembly, and electrode terminals connected to the electrode assembly.

When a secondary battery is exposed to a high-temperature environment or a short circuit occurs, gas may be generated inside the secondary battery because of decomposition of an electrolyte accommodated inside a case and electrode reactions, and a swelling phenomenon in which the case swells may occur. The swelling may cause the case of the secondary battery to rupture, and ignition or explosion caused by thermal runaway may occur.

The above information disclosed in this section is for enhancement of understanding of the background of the present disclosure. It may contain information that does not constitute related or prior art.

### SUMMARY

An object of the present disclosure is to provide a case for a secondary battery capable of solving the above-described problems, a secondary battery including the case, and a method of manufacturing the secondary battery.

These and other aspects and features of the present disclosure will be described in or will be apparent from the following description of embodiments of the present disclosure.

According to some embodiments of the present disclosure, a case for a secondary battery includes a body including an accommodation portion configured to accommodate an electrode assembly, a cover configured to seal an open end of the accommodation portion, an electrolyte injection hole formed on one side of the body, and a sealing member attached to the one side and sealing the electrolyte injection hole, wherein the sealing member includes an adhesive layer bonded to the body and a metal layer laminated on the adhesive layer.

In some embodiments, the sealing member may be configured to rupture when a pressure inside the accommodation portion exceeds a predetermined threshold.

In some embodiments, a vent line configured to induce rupture may be formed on the metal layer, and the vent line may have a thickness less than other regions of the metal layer.

In some embodiments, the metal layer may include at least one of stainless steel, copper, and nickel.

In some embodiments, the adhesive layer may include a polyphosphoric acid (PPA)-based binder.

In some embodiments, the sealing member further may include a protective layer laminated on the metal layer.

In some embodiments, the protective layer may include polyethylene terephthalate (PET) or polyamide.

In some embodiments, a size of the sealing member may be greater than a size of the electrolyte injection hole, and the sealing member may cover the electrolyte injection hole in a thickness direction of the sealing member, the thickness direction being a direction towards the body from the metal layer.

In some embodiments, a shape of the sealing member may be circular or rectangular.

In some embodiments, a lower surface of the adhesive layer may be coplanar with an upper surface of the one side of the body.

In some embodiments, the body and the cover may include stainless steel.

In some embodiments, a secondary battery includes an electrode assembly including a first electrode, a second electrode, and a separator located between the first electrode and the second electrode, and a case configured to accommodate the electrode assembly, wherein the case includes a body including an accommodation portion configured to accommodate the electrode assembly, a cover configured to seal an open end of the accommodation portion, an electrolyte injection hole formed on one side of the body, and a sealing member attached to the one side, the sealing member sealing the electrolyte injection hole, wherein the sealing member includes an adhesive layer bonded to the body and a metal layer laminated on the adhesive layer.

In some embodiments, the secondary battery may further include a first electrode terminal located on the one side of the body and electrically connected to the first electrode, and a second electrode terminal located on the one side of the body and electrically connected to the second electrode.

In some embodiments, the sealing member may be spaced apart from the first electrode terminal and the second electrode terminal.

In some embodiments, the sealing member may be configured to rupture when the pressure inside the sealed accommodation portion, after the sealing member is attached to the one side, exceeds a predetermined threshold.

In some embodiments, the adhesive layer may include a polyphosphoric acid (PPA)-based binder.

In some embodiments, the metal layer may include at least one of stainless steel, copper, and nickel.

In some embodiments, the sealing member may further include a protective layer laminated on the metal layer.

In some embodiments, a method of manufacturing a secondary battery includes forming an electrode assembly, a body having an electrolyte injection hole formed on one side of the body, and a cover corresponding to the body, inserting the electrode assembly into the body through an open end of the body, coupling the cover to the open end of the body, resulting in a case including the body and the cover, injecting an electrolyte into the case through the electrolyte injection hole, and attaching a sealing member to the one side, the sealing member sealing the electrolyte injection hole, wherein the sealing member includes an adhesive layer bonded to the body and a metal layer laminated on the adhesive layer.

In some embodiments, the sealing member may be configured to rupture when internal pressure of the case, after the sealing member is attached to the one side, exceeds a predetermined threshold.

According to some embodiments of the present disclosure, the sealing member may regulate internal pressure so that internal pressure of the case does not exceed a predetermined threshold. Specifically, under thermal-runaway conditions caused by abnormal behavior of the secondary battery, the sealing member may rupture and thereby reduce internal pressure of the accommodation portion.

According to some embodiments of the present disclosure, during a process in which an electrolyte is injected into the case accommodating the electrode assembly and the case is sealed by the sealing member, a vent may be formed only by modifying the sealing member, without an additional vent part that is separately formed for gas discharge.

According to some embodiments of the present disclosure, because the sealing member includes the metal layer, moisture penetration into an interior of the case may be prevented, and corrosion may be suppressed by inhibiting chemical reactions between an electrolyte and moisture.

According to some embodiments of the present disclosure, when the case and the metal layer use an identical material, a potential difference may be reduced, thereby suppressing galvanic corrosion.

According to some embodiments of the present disclosure, when the sealing member further includes the protective layer laminated on the metal layer, the metal layer may be physically protected from foreign substances.

According to some embodiments of the present disclosure, when the metal layer includes the vent line, gas may be discharged through a through-hole formed by rupture of the vent line before a temperature that causes ignition is reached, such that internal pressure may be reduced, electrolyte may be released, and thermal runaway may be prevented in advance. In this case, a process of manufacturing a separate vent portion having a notch in a can-type secondary battery may be omitted.

However, aspects and features of the present disclosure are not limited to those described above, and other aspects and features not mentioned will be clearly understood by a person skilled in the art from the detailed description, described below.

### BRIEF DESCRIPTION OF DRAWINGS

The drawings illustrate embodiments of the present disclosure, and further describe aspects and features of the present disclosure together with the detailed description of the present disclosure. Thus, the present disclosure is not limited to the drawings.

FIG. 1 is a schematic diagram illustrating an example of a case for a secondary battery according to an embodiment of the present disclosure.

FIG. 2 illustrates an example of the case for a secondary battery according to an embodiment of the present disclosure.

FIG. 3 illustrates an example of a sealing member according to an embodiment of the present disclosure.

FIG. 4 illustrates an example of a sealing member according to an embodiment of the present disclosure.

FIG. 5 illustrates an example of a positional relationship between a sealing member and an electrolyte injection hole of the case for a secondary battery according to an embodiment of the present disclosure.

FIG. 6 illustrates an example of a positional relationship between a sealing member and an electrolyte injection hole of the case for a secondary battery according to an embodiment of the present disclosure.

FIG. 7 illustrates an example of a metal layer according to an embodiment of the present disclosure.

FIG. 8 is a schematic diagram illustrating an example of a secondary battery according to an embodiment of the present disclosure.

FIG. 9 is a cross-sectional view illustrating an example of the secondary battery according to an embodiment of the present disclosure.

FIG. 10 is a flowchart illustrating an example of a method of manufacturing a secondary battery according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way. Therefore, the embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

Also, it will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, in the figures, dimensions of the various elements, layers, etc. may be exaggerated for clarity of illustration. The same reference numerals designate the same elements.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, etc. may be used herein to describe various elements, these elements should not be limited by these terms. These terms are only used to distinguish one element from another element. Thus, a first element could be termed a second element unless the context clearly indicates otherwise.

Throughout the specification, unless otherwise stated, each element may be singular or plural.

Arranging an arbitrary element “above (or below)” or “on (under)” another element may mean that the arbitrary element may be located in contact with the upper (or lower) surface of the element, and another element may also be interposed between the element and the arbitrary element located on (or under) the element.

In addition, it will be understood that when a component is referred to as being “linked,” “coupled,” or “connected” to another component, the elements may be directly “coupled,” “linked” or “connected” to each other, or another component may be “interposed” between the components”. It will also be understood that when an element is referred to as being “electrically coupled” to another element, it may be directly coupled to the other element or intervening elements may be present.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to be limiting of the present disclosure.

In the present disclosure, sizes and relative sizes of regions illustrated in the drawings may be exaggerated for clarity of description. That is, sizes illustrated in the drawings are provided only for ease of understanding and are not limiting. In addition, identical reference numerals throughout the entire specification designate identical constituent elements.

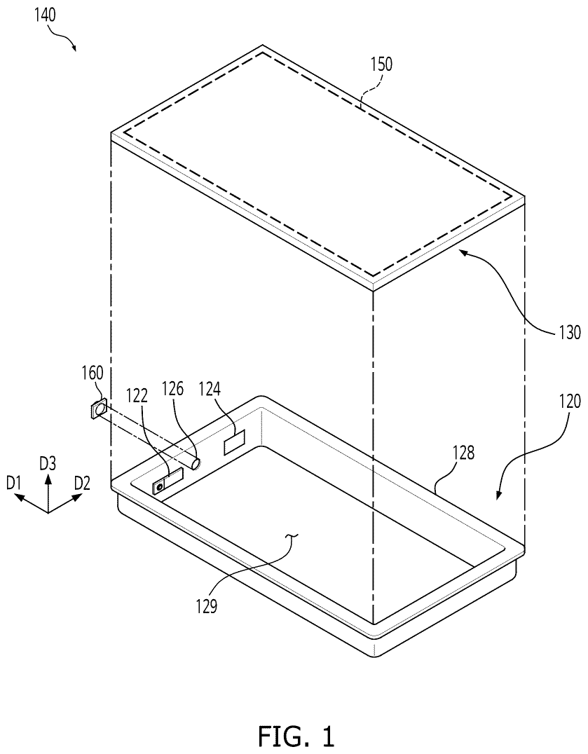

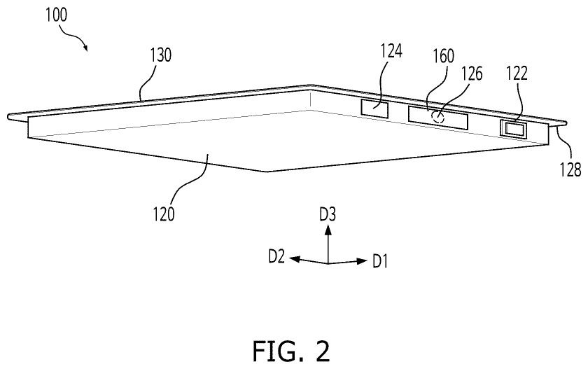

FIG. 1 is a schematic diagram illustrating an example of a case 140 for a secondary battery according to an embodiment of the present disclosure. FIG. 2 illustrates an example of the case 140 for a secondary battery according to an embodiment of the present disclosure.

Referring to FIG. 1, the case 140 for a secondary battery according to an embodiment of the present disclosure may include a body 120 including an accommodation portion 129 configured to accommodate an electrode assembly, a cover 130 configured to seal an open end of the accommodation portion 129, an electrolyte injection hole 126 formed on one side of the body 120, and a sealing member 160 attached to the one side to seal the electrolyte injection hole 126.

The case 140 forms an overall exterior of the secondary battery and may be formed of a conductive metal, such as aluminum, an aluminum alloy, or nickel-plated steel. Specifically, the body 120 and the cover 130 may be formed of an identical metallic material. The metallic material may include stainless steel or aluminum; however, this is illustrative, and the case 140 may be formed of diverse metallic materials that satisfy strength required for the secondary battery and resistance to external impact.

The body 120 may include the accommodation portion 129 that is open at one end to accommodate an electrode assembly. The accommodation portion 129 of the body 120 may be formed to have an interior space in which the electrode assembly is accommodated by inserting the electrode assembly into the accommodation portion 129, for example. A planar shape of the accommodation portion 129 of the case 140 may be rectangular, for example, but is not limited thereto.

According to an embodiment of the present disclosure, the body 120 may include a flange portion 128 extending around the open end of the accommodation portion 129, and the cover 130 may be coupled to the flange portion 128 to seal the open end of the accommodation portion 129.

Specifically, the cover 130 may be formed as a flat plate located on the flange portion 128 of the body 120 to seal the open end of the accommodation portion 129. For example, the cover 130 may be formed as a flat plate having a size sufficient to cover the flange portion 128, and may be arranged so that a lower surface of the cover 130 makes surface contact with an upper surface of the flange portion 128. By coupling the flange portion 128 and the cover 130, the body 120 and the cover 130 may form an integral structure.

The case 140 for a secondary battery may further include a bonding line 150 located on the flange portion 128 and the cover 130 corresponding to the flange portion 128. The bonding line 150 may designate a region in which the flange portion 128 and the cover 130 are coupled to each other so that the accommodation portion 129 is sealed. For example, the bonding line 150 may include a weld portion where the flange portion 128 and the cover 130 are welded and coupled by a laser welding machine. Similarly, the bonding line 150 may include an adhesive portion in which the flange portion 128 and the cover 130 are coupled to each other by an adhesive. The bonding line 150 may be formed along edges of the cover 130 and the flange portion 128.

For reference, a D1 direction may designate a length direction of the case 140, a D2 direction may designate a width direction of the case 140, and a D3 direction may designate a thickness direction of the case 140.

Referring to FIG. 2, the body 120 and the cover 130 may be joined together to form an exterior of a secondary battery 100. For example, the body 120 and the cover 130 may be metal-joined (for example, welded, brazed, or soldered). In this case, the flange portion 128 of the body 120 and an edge of the cover 130 may be joined together. In addition, after the body 120 and the cover 130 are joined, at least part of the flange portion 128 may be cut by a laser to improve energy density of the secondary battery 100.

The case 140 for a secondary battery may further include a first electrode terminal 122 located on one side of the body 120 and electrically connected to a first electrode of the electrode assembly, and a second electrode terminal 124 located on the same one side of the body 120 and electrically connected to a second electrode of the electrode assembly. The first electrode terminal 122 may be electrically connected to a first electrode tab of the electrode assembly, and the second electrode terminal 124 may be electrically connected to a second electrode tab of the electrode assembly. The first electrode terminal 122 and the second electrode terminal 124 may be formed on another side surface (for example, a surface in the D1 direction of the body 120) of the body 120. Positions of the first electrode terminal 122 and the second electrode terminal 124 according to the present disclosure are not limited to positions illustrated in FIGS. 1 and 2, and may have various modifications.

The body 120 may include the electrolyte injection hole 126. For example, the electrolyte injection hole 126 may be a through-hole formed in one surface (for example, a surface in the D1 direction) of the body 120. After the body 120 and the cover 130 are joined and sealed, the electrolyte injection hole 126 may be used to inject an electrolyte into an interior of the case 140 of the secondary battery 100.

The electrolyte injection hole 126 may connect the sealed accommodation portion 129, which is sealed by joining the body 120 and the cover 130, and the outside of the accommodation portion 129. After the electrolyte is injected, the electrolyte injection hole 126 may be sealed by the sealing member 160.

Positions of the electrolyte injection hole 126 and the sealing member 160 that seals the electrolyte injection hole 126 are not limited as long as positions are on one side of the body 120 or the cover 130. Specifically, in FIG. 1, the electrolyte injection hole 126 is illustrated as being formed on one side of the body 120 so as to be located between the first electrode terminal 122 and the second electrode terminal 124, but is not limited thereto. For example, the electrolyte injection hole 126 and the sealing member 160 that seals the electrolyte injection hole 126 may be located at a center of the flat plate that constitutes the cover 130 or at another side portion of the body 120.

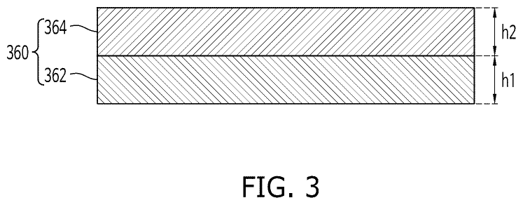

The sealing member 160 may be configured to rupture when internal pressure of the sealed accommodation portion 129 exceeds a predetermined threshold. By rupture of the sealing member 160, gas inside the case 140 may be discharged to the outside through the electrolyte injection hole 126, and excessive internal pressure in the case 140 may be prevented. Through this, the sealing member 160 may perform a function of regulating pressure. Under thermal-runaway conditions caused by an increase in internal pressure due to abnormal behavior of a secondary battery, the sealing member 160 may rupture and reduce internal pressure of the accommodation portion 129. A configuration and a form of the sealing member 160 will be described below with reference to FIGS. 3 to 7.

According to some embodiments of the present disclosure, during a process in which an electrolyte is injected into a case accommodating an electrode assembly and the case is sealed by a sealing member, a vent may be formed by modifying the sealing member, without a separate vent part that is formed for gas discharge.

FIG. 3 illustrates an example of a sealing member 360 according to an embodiment of the present disclosure.

Referring to FIG. 3, the sealing member 360 may include an adhesive layer 362 bonded to a body and a metal layer 364 laminated on the adhesive layer 362.

A material of the metal layer 364 may include at least one of stainless steel, copper, or nickel. The metal layer 364 may be formed as a thin film on the adhesive layer 362. When an existing aluminum material is used, moisture penetration into the battery interior may be prevented; however, when the metal layer 364 is electrically connected to an outer case of the secondary battery that functions as a negative electrode, corrosion caused by ionization may occur. When the metal layer 364 is configured with a material having excellent corrosion resistance, chemical reactions with an electrolyte and moisture may be suppressed, and corrosion may be prevented.

According to an embodiment, when the case and the metal layer 364 use an identical material, a potential difference may be reduced, and galvanic corrosion may be suppressed. For example, the case and the metal layer 364 may both be formed from stainless steel. With this configuration, the sealing member 360 may prevent moisture from penetrating into the interior of the case and may suppress corrosion.

A material of the adhesive layer 362 may be formed from a PPA-based binder. According to an embodiment, the adhesive layer 362 may be formed of a material having high adhesive strength to couple the metal layer 364 and an outer surface of the case. For example, the adhesive layer 362 may be formed of a material including epoxy resin, polyurethane adhesive, silicone adhesive, cyanoacrylate, polyvinyl acetate, polyimide adhesive, polyamide adhesive, a UV-curable adhesive, or a combination thereof. However, the material of the adhesive layer 362 is not limited to the above-listed materials, and may include various materials having excellent adhesiveness capable of coupling the metal layer 364 and the case.

The metal layer 364 may have a thickness h1 in a vertical direction of an outer portion of the body (that is, the D1 direction of FIG. 1), and the adhesive layer 362 may have a thickness h2 in the same direction. According to an embodiment, the thickness h1 of the metal layer 364 may be formed to be 1 μm to 60 μm. By forming the thickness of the metal layer 364 to be 1 μm or more, moisture penetration from the outside may be prevented. According to an embodiment, the adhesive layer 362 may have a thickness h2 of 30 μm, 44 μm, or 50 μm, but is not limited thereto and may be formed to have a thickness of 10 μm to 60 μm. By forming the thickness of the adhesive layer 362 to be 10 μm or more, ease and efficiency of fabrication may be secured.

According to an embodiment, the adhesive layer 362 may further include one or more binders. Representative examples of the binder include, but are not limited to, polyvinyl alcohol, carboxymethyl cellulose, hydroxypropyl cellulose, diacetyl cellulose, polyvinyl chloride, carboxylated polyvinyl chloride, polyvinyl fluoride, a polymer including ethylene oxide, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, and nylon.

The coupling manner as disclosed herein is not limited to the embodiment described above, and various coupling manners capable of sealing the case may be used. For example, an outer portion of the case and the sealing member 360 may be coupled by laser welding, ultrasonic welding, brazing, laser brazing, welding, soldering, or the like.

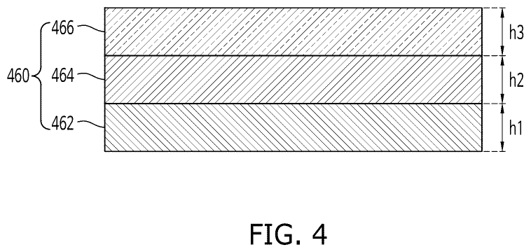

FIG. 4 illustrates an example of a sealing member 460 according to an embodiment of the present disclosure.

Referring to FIG. 4, the sealing member 460 may further include a protective layer 466 laminated on the metal layer. For example, the metal layer 464 may be laminated on an adhesive layer 462, and the protective layer 466 may be laminated on the metal layer 464. With this configuration, the metal layer 464 may be physically protected from foreign substances. According to an embodiment, a material of the protective layer 466 may include PET or polyamide. However, the material of the protective layer 466 is not limited to the above-listed materials, and may include various materials having high strength against external impact or contact, depending on selection.

According to an embodiment, the protective layer 466 may have a thickness h3 in a vertical direction of an outer portion of the case (that is, the D1 direction of FIG. 1). The protective layer 466 may have a thickness h3 of 15 μm or 20 μm, but is not limited thereto and may be formed to have a thickness h3 of 10 μm to 20 μm.

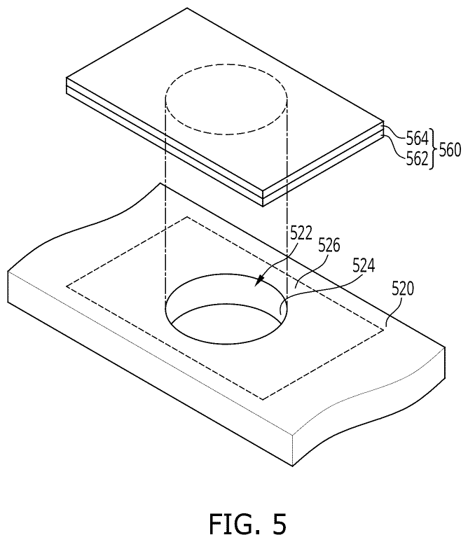

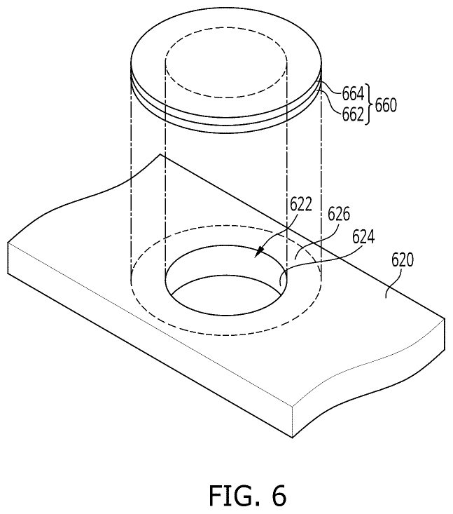

FIG. 5 illustrates an example of a positional relationship between a sealing member 560 and an electrolyte injection hole of the case for a secondary battery according to an embodiment of the present disclosure. FIG. 6 illustrates an example of a positional relationship between a sealing member 660 and an electrolyte injection hole of the case for a secondary battery according to an embodiment of the present disclosure.

Referring to FIGS. 5 and 6, a size of each sealing member 560, 660 may be greater than a size of each electrolyte injection hole 522, 622, and each sealing member 560, 660 may cover the corresponding electrolyte injection hole 522, 622 in a thickness direction of the sealing member 560, 660. For example, when viewed in the D1 direction of FIG. 1, the size of each sealing member 560, 660 may be greater than the size of the corresponding electrolyte injection hole 522, 622. For example, an adhesive layer 562, 662 formed on a lower end of each sealing member 560, 660 may completely cover an inner diameter 524, 624 of the corresponding electrolyte injection hole 522, 622. According to an embodiment, each adhesive layer 562, 662 may be attached to a peripheral portion 526, 626 that surrounds the corresponding electrolyte injection hole 522, 622. The peripheral portion 526, 626 may be formed on an upper surface of one side of each body 520, 620 to surround the electrolyte injection hole 522, 622. A lower surface of each adhesive layer 562, 662 may be coplanar with an upper surface of one side of the corresponding body 520, 620.

According to an embodiment, each metal layer 564, 664 may be formed with an identical area and an identical shape to the corresponding adhesive layer 562, 662. For example, each metal layer 564, 664 and the corresponding adhesive layer 562, 662 may be completely overlapped with each other in a thickness direction of the corresponding sealing member 560, 660.

Although not illustrated in FIGS. 5 and 6, according to an embodiment, a protective layer laminated on each metal layer 564, 664 may be formed with an identical area and an identical shape to the corresponding metal layer 564, 664. According to another embodiment, the protective layer may be formed with a larger area than the corresponding metal layer 564, 664 so that the metal layer 564, 664 is not exposed to the outside. For example, the protective layer may be formed to surround a side surface of the corresponding metal layer 564, 664. With this configuration, the protective layer may physically protect the corresponding metal layer 564, 664 from foreign substances.

According to an embodiment, a shape of each sealing member 560, 660 may be circular or rectangular. For example, each adhesive layer 562, 662, each metal layer 564, 664, and/or each protective layer may be circular or rectangular. However, the present disclosure is not limited thereto, and various shapes of the sealing members 560, 660 may be included as long as the inner diameter 524, 624 of the corresponding electrolyte injection hole 522, 622 is not exposed to the outside.

According to an embodiment, each adhesive layer 562, 662 may be adhered to the corresponding peripheral portion 526, 626 that surrounds the electrolyte injection hole 522, 622. For example, an area on each sealing member 560, 660 that does not contact the corresponding peripheral portion 526, 626 may not have the adhesive layer 562, 662. According to another embodiment, the adhesive layer 562, 662 may not be formed on the sealing member 560, 660 and may be formed instead on the corresponding peripheral portion 526, 626 of the electrolyte injection hole 522, 622 to attach the metal layer 564, 664, thereby sealing the electrolyte injection hole 522, 622.

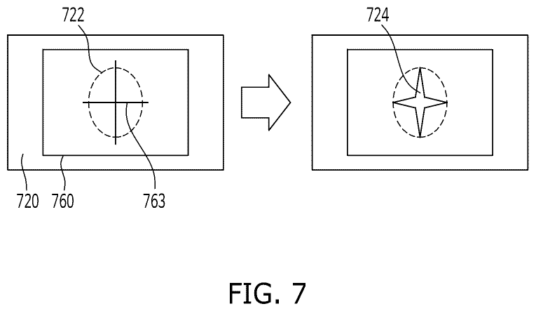

FIG. 7 illustrates an example of a metal layer according to an embodiment of the present disclosure.

FIG. 7 illustrates a view as seen toward an electrolyte injection hole 722 of a secondary battery. As illustrated on the left side of FIG. 7, a sealing member 760 may be located on an upper surface of one side of a body 720. The sealing member 760 located on a peripheral portion of the electrolyte injection hole 722 may have a vent line 763. According to an embodiment, the vent line 763 configured to induce rupture may be formed on the metal layer, which is one constituent element of the sealing member 760. When the vent line 763 ruptures, a through-hole 724 may be formed as illustrated on the right side of FIG. 7. In FIG. 7, the vent line 763 is illustrated in a “+” shape, but may be circular, rectangular, or any other shape, and is not limited to the illustrated shape.

The vent line 763 may be configured to have a thickness less than other regions of the metal layer. With this configuration, when internal pressure exceeds a predetermined threshold, the through-hole 724 may be formed more easily. A thickness of the vent line 763 may be changed according to the predetermined threshold.

According to an embodiment, the through-hole 724 may be formed by rupture of the vent line 763. For example, as charge-discharge proceeds, an internal temperature of the case 140 may rise, an electrolyte may vaporize, and internal pressure may rise. When the internal pressure becomes equal to or greater than the threshold (e.g., when the internal pressure exceeds the threshold), the vent line 763 may rupture and the through-hole 724 may be formed. Here, the threshold may be identical to cell internal pressure corresponding to an ignition temperature of the secondary battery. Therefore, the threshold may vary according to types, sizes, and capacities of secondary batteries, and is not limited thereto.

When the secondary battery reaches an ignition temperature, a thermal-runaway phenomenon may occur in which ignition occurs. Gas may be discharged through the through-hole 724 formed by rupture of the vent line 763 of the secondary battery before the ignition temperature is reached. The internal pressure may be reduced, and electrolyte may be released, thereby preventing thermal runaway in advance. In this case, there is an advantage in that a process of manufacturing a vent portion having a separate notch in a can-type secondary battery may be omitted.

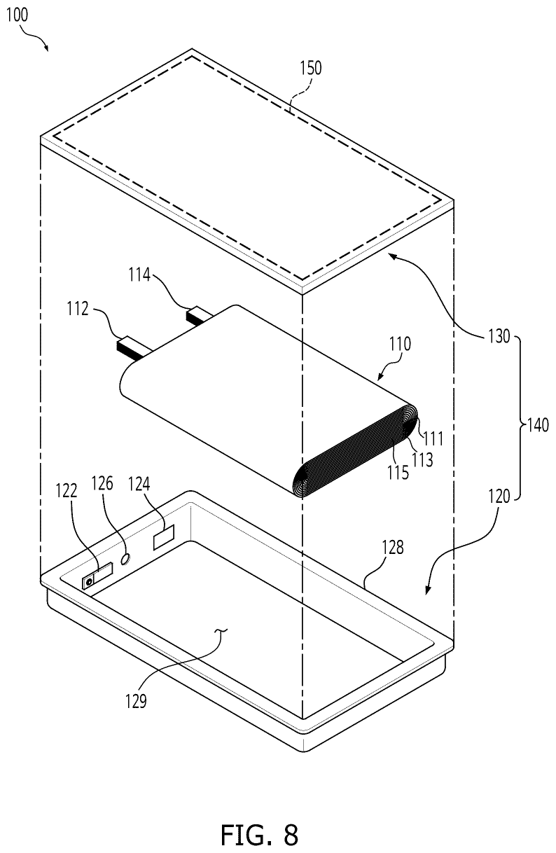

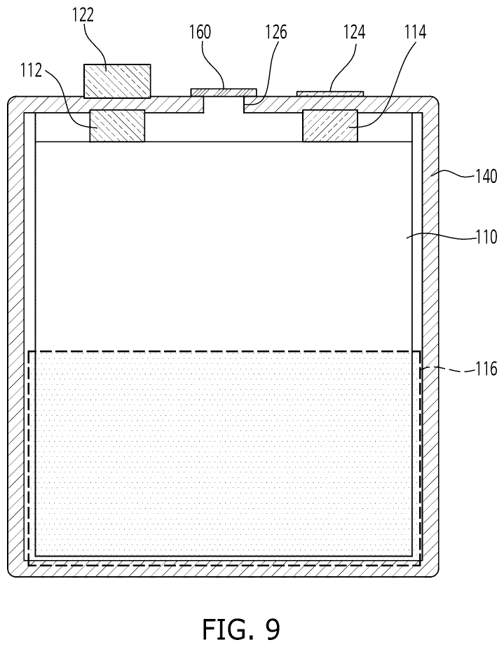

FIG. 8 is a schematic diagram illustrating an example of a secondary battery according to an embodiment of the present disclosure. FIG. 9 is a cross-sectional view illustrating an example of the secondary battery according to an embodiment of the present disclosure. Descriptions of configurations illustrated in FIGS. 8 and 9 that duplicate or overlap those described with reference to FIGS. 1 through 8 are omitted.

Referring to FIG. 8, a secondary battery 100 according to an embodiment of the present disclosure may include an electrode assembly 110 including a first electrode 111, a second electrode 113, and a separator 115 located between the first electrode 111 and the second electrode 113, and a case 140 configured to accommodate the electrode assembly 110.

According to an embodiment, the electrode assembly 110 may be formed by sequentially winding or stacking the first electrode 111, the separator 115, and the second electrode 113. For example, the electrode assembly 110 may be formed in a jelly-roll state by sequentially winding the first electrode 111, the separator 115, and the second electrode 113, and a cavity in which the first electrode 111, the separator 115, and the second electrode 113 are not present may be formed inside (in a core portion) of the jelly-roll.

The first electrode 111 may be an electrode corresponding to a positive electrode or a negative electrode in the electrode assembly 110. The second electrode 113 may be an electrode corresponding to a polarity opposite to that of the first electrode 111. For example, when the first electrode 111 is a positive electrode, the second electrode 113 may be a negative electrode. Conversely, when the first electrode 111 is a negative electrode, the second electrode 113 may be a positive electrode.

The secondary battery 100 illustrated in FIG. 8 may be a can-type secondary battery configured of stainless steel, but the secondary battery according to the present disclosure is not limited thereto and may be any type of secondary battery, such as a prismatic secondary battery configured of aluminum.

The secondary battery 100 may be a lithium battery cell or a sodium battery cell. However, a scope of the present disclosure is not limited thereto, and the secondary battery 100 includes all batteries capable of repeatedly supplying electric power through charging and discharging. In an embodiment, when the secondary battery 100 is a lithium battery cell, life characteristics and high-rate characteristics are excellent, and therefore the lithium battery cell may be used in an electric vehicle. For example, the lithium battery cell may be used in a plug-in hybrid electric vehicle. In addition, the lithium battery cell may be used in fields requiring power storage over a wide range, such as smart phones, tablet PCs, electric bicycles, and power tools, but is not limited thereto.

Referring to FIG. 9, a first electrode tab 112 integrally formed in an uncoated portion of an active material of the first electrode or connected by welding may be electrically connected to the first electrode terminal 122. A second electrode tab 114 integrally formed in an uncoated portion of an active material of the second electrode or connected by welding may be electrically connected to the second electrode terminal 124. Alternatively, a first lead tab connected to the first electrode tab 112 may be electrically connected to the first electrode terminal 122, and a second lead tab connected to the second electrode tab 114 may be electrically connected to the second electrode terminal 124. The first electrode tab 112 and the second electrode tab 114 may designate (or refer to) electrode-tab groups in which electrode tabs of respective electrode plates wound or stacked are stacked.

The electrode assembly 110 may undergo an aging process in which the electrode assembly 110 is saturated with an electrolyte 116 injected through the electrolyte injection hole 126. The electrolyte 116 is an electrolyte in a liquid state and may provide a migration path of ions between the positive electrode and the negative electrode so that a battery reaction may proceed smoothly. In addition, the electrolyte 116 may stabilize surfaces of the positive electrode and the negative electrode and may improve life and cell characteristics of the secondary battery. For example, in the secondary battery, the electrolyte 116 may largely include an electrolyte salt, an organic solvent, and/or an additive.

The electrolyte injection hole 126 is a through-hole for injecting the electrolyte 116 into an interior of the case 140. In a comparative example according to the present disclosure, the electrolyte injection hole 126 may be sealed by mechanically press-fitting a sealing member 160, which has a diameter larger than that of the electrolyte injection hole 126, into the electrolyte injection hole 126. The sealing member illustrated in FIG. 9 may have the same or similar configuration as the sealing members 360, 460, 560, and 660 described with reference to FIGS. 3 to 7.

According to an embodiment, the sealing member 160 may be spaced apart from the first electrode terminal 122 and the second electrode terminal 124. For example, the sealing member 160 may be formed not to contact the first electrode terminal 122 and the second electrode terminal 124 in a vertical direction of an outer portion of the body 120 in which the electrolyte injection hole 126 is formed but is not limited thereto.

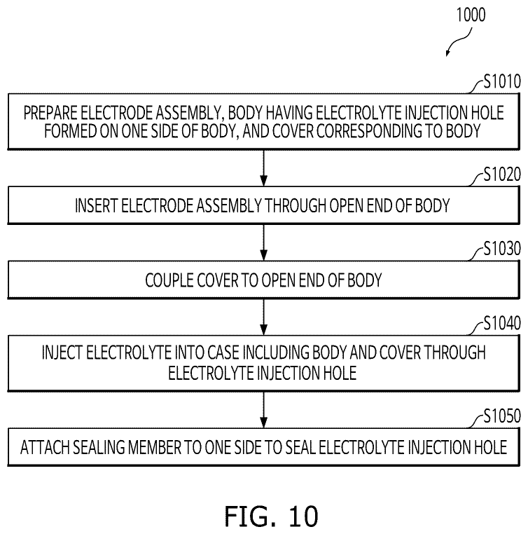

FIG. 10 is a flowchart of a method of manufacturing a secondary battery according to an embodiment of the present disclosure.

The method of manufacturing a secondary battery may start with preparing an electrode assembly, a body having an electrolyte injection hole formed on one side of the body, and a cover corresponding to the body (S1010). A material of the body and the cover may include stainless steel (SUS).

Then, the electrode assembly may be inserted through an open end of the body (S1020).

Then, the cover may be coupled to the open end of the body (S1030).

Then, an electrolyte may be injected into a case including the body and the cover through the electrolyte injection hole (S1040).

Then, a sealing member may be attached to the one side to seal the electrolyte injection hole (S1050). The sealing member may include an adhesive layer bonded to the body and a metal layer laminated on the adhesive layer. According to an embodiment, the sealing member may be configured to rupture when internal pressure of the sealed case exceeds a predetermined threshold.

According to an embodiment, a size of the sealing member may be greater than a size of the electrolyte injection hole, and the sealing member may cover the electrolyte injection hole in a thickness direction of the sealing member. For example, a lower surface of the adhesive layer may be coplanar with an upper surface of the one side of the body. According to an embodiment, a shape of the sealing member may be circular or rectangular.

According to an embodiment, a material of the metal layer may include at least one of stainless steel, copper, or nickel. A vent line configured to induce rupture may be formed on the metal layer, and the vent line may have a thickness less than other regions of the metal layer. A material of the adhesive layer may include a PPA-based binder.

According to an embodiment, the sealing member may further include a protective layer laminated on the metal layer. A material of the protective layer may include PET or polyamide.

The flowchart of FIG. 10 and the foregoing description are merely an example of the present disclosure, and the scope of the present disclosure is not limited to the flowchart of FIG. 10 and the foregoing description. For example, one or more steps of the flowchart and the foregoing description may be added, modified, or deleted; an order of one or more steps may be changed; and one or more steps may be performed simultaneously.

Although the present disclosure has been described above with respect to embodiments thereof, the present disclosure is not limited thereto. Various modifications and variations can be made thereto by those skilled in the art within the spirit of the present disclosure.

### Explanation of Reference Symbols

120: body
122: first electrode terminal
124: second electrode terminal
126: electrolyte injection hole
129: accommodation portion
128: flange portion
130: cover
140: case
150: bonding line
160: sealing member

What is claimed is:

1. A case for a secondary battery comprising:
a body comprising an accommodation portion configured to accommodate an electrode assembly;
a cover configured to seal an open end of the accommodation portion;
an electrolyte injection hole formed in one side of the body; and
a sealing member attached to the one side and sealing the electrolyte injection hole,
wherein the sealing member comprises:
an adhesive layer bonded to the body; and
a metal layer laminated on the adhesive layer.

2. The case as claimed in claim 1, wherein the sealing member is configured to rupture when a pressure inside the accommodation portion exceeds a predetermined threshold.

3. The case as claimed in claim 2, wherein a vent line that is configured to induce rupture is formed in the metal layer, and
wherein the vent line has a thickness that is less than other regions of the metal layer.

4. The case as claimed in claim 1, wherein the metal layer comprises at least one of stainless steel, copper, and nickel.

5. The case as claimed in claim 1, wherein the adhesive layer comprises a polyphosphoric acid (PPA)-based binder.

6. The case as claimed in claim 1, wherein the sealing member further comprises a protective layer laminated on the metal layer.

7. The case as claimed in claim 6, wherein the protective layer comprises polyethylene terephthalate (PET) or polyamide.

8. The case as claimed in claim 1, wherein a size of the sealing member is greater than a size of the electrolyte injection hole, and
wherein the sealing member covers the electrolyte injection hole in a thickness direction of the sealing member, with the thickness direction being a direction towards the body from the metal layer.

9. The case as claimed in claim 1, wherein the sealing member is circular shaped or rectangular shaped.

10. The case as claimed in claim 1, wherein a lower surface of the adhesive layer is coplanar with an upper surface of the one side of the body.

11. The case as claimed in claim 1, wherein the body and the cover comprise stainless steel.

12. A secondary battery comprising:
an electrode assembly comprising:
a first electrode;
a second electrode; and
a separator located between the first electrode and the second electrode; and
a case configured to accommodate the electrode assembly,
wherein the case comprises:
a body comprising an accommodation portion configured to accommodate the electrode assembly;
a cover configured to seal an open end of the accommodation portion;
an electrolyte injection hole formed in one side of the body; and
a sealing member attached to the one side and sealing the electrolyte injection hole,
wherein the sealing member comprises:
an adhesive layer bonded to the body; and
a metal layer laminated on the adhesive layer.

13. The secondary battery as claimed in claim 12, further comprising:
a first electrode terminal located on the one side of the body and electrically connected to the first electrode; and
a second electrode terminal located on the one side of the body and electrically connected to the second electrode.

14. The secondary battery as claimed in claim 13, wherein the sealing member is spaced apart from the first electrode terminal and the second electrode terminal.

15. The secondary battery as claimed in claim 12, wherein the sealing member is configured to rupture when a pressure inside the accommodation portion exceeds a predetermined threshold.

16. The secondary battery as claimed in claim 12, wherein the adhesive layer comprises a polyphosphoric acid (PPA)-based binder.

17. The secondary battery as claimed in claim 12, wherein the metal layer comprises at least one of stainless steel, copper, and nickel.

18. The secondary battery as claimed in claim 12, wherein the sealing member further comprises a protective layer laminated on the metal layer.

19. A method of manufacturing a secondary battery comprising:
forming:
an electrode assembly;
a body having an electrolyte injection hole formed in one side of the body; and
a cover corresponding to the body;
inserting the electrode assembly into the body through an open end of the body;
coupling the cover to the open end of the body;
injecting an electrolyte into the case through the electrolyte injection hole; and
attaching a sealing member to the one side, the sealing member sealing the electrolyte injection hole,
wherein the sealing member comprises:
an adhesive layer bonded to the body; and
a metal layer laminated on the adhesive layer.

20. The method as claimed in claim 19, wherein the sealing member is configured to rupture when internal pressure of the case, after the sealing member is attached to the one side, exceeds a predetermined threshold.
